(19) United States
(12) Patent Application Publication
(10) Pub. No.: US 2014/0102167 A1
(43) Pub. Date: Apr. 17, 2014

(54) FORCE PLATFORM

(71) Applicant: NORTHERN DIGITAL, INC., Waterloo (CA)

(72) Inventors: David MacNeil, Waterloo (CA); Melanie Scholz, Kitchener (CA); Bob Bordignon, Kitchener (CA)

(73) Assignee: NORTHERN DIGITAL, INC., Waterloo (CA)

(21) Appl. No.: 13/800,894

(22) Filed: Mar. 13, 2013

Related U.S. Application Data
(60) Provisional application No. 61/713,308, filed on Oct. 12, 2012.

(51) Int. Cl. G01L 25/00; G01B 7/31

(52) U.S. Cl. CPC G01L 25/00; G01B 7/31
USPC 73/1.15; 33/533; 29/407.01

(57) ABSTRACT

In one aspect, a force platform includes indicators at known locations with respect to applied forces used during the calibration of the force platform, the indicators being usable by a spatial measurement system to determine the location of the indicators in a coordinate system external to the force platform.

### RELATED APPLICATIONS

Pursuant to 35 USC §119(e), this application claims the benefit of prior U.S. Provisional Application 61/713,308, filed Oct. 12, 2012. The provisional application is incorporated by reference in its entirety.

### TECHNICAL FIELD

This disclosure relates to a force platform for measuring ground reaction forces.

### BACKGROUND

Force platforms are devices used to measure ground reaction forces, often for the purpose of measuring ground reaction forces created by a research subject (e.g., a human or other animal subject). Kinesiology and biomechanics researchers are sometimes interested in studying these forces along with the research subject's motion that creates these forces. A researcher may use a spatial motion capture system to capture research subject's motion, which can be described by 3-dimensional coordinates.

### SUMMARY

In one aspect, a force platform includes indicators at known locations with respect to applied forces used during the calibration of the force platform.

In another aspect, a method includes installing indicators or markers on the force platform such that the spatial coordinates of the indicators or markers are at known locations with respect to applied forces used during the calibration of the force platform.

In another aspect, a method includes measuring spatial coordinates of markers or indicators installed on a force platform, and using the spatial coordinates to transform locations of forces applied to the force platform into a coordinate system external to the force platform.

In another aspect, a force platform includes indicators at known locations with respect to applied forces used during the calibration of the force platform, the indicators being usable by a spatial measurement system to determine the location of the indicators in a coordinate system external to the force platform. In some implementations, the indicators could be magnets, divots, etched patterns, or painted patterns. In some implementations, the force platform may comprise pressure transducers that measure the applied forces.

In another aspect, an alignment tool includes recesses capable of each receiving an indicator usable by a spatial measurement system to determine the location of the indicators in a coordinate system external to a force platform when the indicators are installed on the force platform, and magnets arranged in a pattern corresponding to a pattern of magnets in the force platform. In some implementations, the indicators could be magnets, divots, etched patterns, painted patterns, or light emitting diodes. In some implementations, the alignment tool may be rigid.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a force platform with an alignment plate and coupling magnets.

FIG. 2 shows an alignment tool with integrated magnets and locating holes for reflective spheres.

FIG. 3 shows an alignment tool with integrated magnets and locating holes for light emitting diodes.

FIG. 4 shows a top plate of the force platform with an applied force and integrated coupling magnets.

FIGS. 5 and 6 are flowcharts.

FIG. 7 is a computer system.

Like reference symbols in the various drawings indicate like elements.

### DETAILED DESCRIPTION

A force platform measures ground reaction forces, which are forces exerted by the ground upon another object. A force platform can be used by researchers investigating the forces exerted by objects. Sometimes a force platform is used with a spatial motion capture system. In order to accurately determine the relationship between measured ground reaction forces and the measured 3-dimensional motion coordinates it may be of interest that the spatial motion capture system and the force platform are synchronized (e.g., spatially, temporally, etc.). A force platform may provide a way of spatially locating the forces measured by the force platform with the coordinate system of a spatial motion capture system (or any other coordinate system).

In some techniques, indicators can be installed on a force platform. The indicators can be used to locate the position and orientation of the force platform with respect to a coordinate system external to the force platform (e.g., a utilized coordinate system that is different from a coordinate system used with the force platform). The indicators installed on the force platform are at known positions with respect to the force platform coordinate system and can be measured using an external spatial measuring system. For example, the indicators can be placed at known locations with respect to applied forces used during the calibration of the force platform. The indicators can be, for example, magnets, divots or other 3-dimensional features, or etched or painted patterns or other 2-dimensional features.

Sometimes, researchers or other users determine the spatial location and orientation of a force plate with respect to the coordinate system of a spatial motion capture system by using specialized force application tools that are equipped with spatial measurement targets (e.g., sensed by the spatial motion capture system). These specialized force application tools are used to apply a force to the force platform while the location of the tool is measured by a spatial motion capture system.

These specialized force application tools may suffer in accuracy. For example, the specialized force application tools may be able to generate only limited forces, or the specialized force application tools may not manufactured with appropriate accuracy with respect to the intended geometry of the specialized force application tools (e.g., necessary for accurate spatial alignment of a force platform with a spatial motion capture system), or the specialized force application tools may easily deform during usage when a force is applied (thus changing the geometry and therefore decreasing the accuracy of the specialized force application tools). Additionally, the specialized force application tools may call for the spatial measurement targets used for the specialized force application tools to be offset from the force platform by a considerable distance (e.g., 12 to 24 inches or more). This offset of the spatial measurement targets can decrease spatial alignment accuracy of the force platform proportional to the offset distance. The methods of using these specialized force application tools may also call for a high skill level of the user of the specialized force application tools and may be time consuming in order to develop a spatial synchronization between the force platform and the spatial motion capture system. Accordingly, a force platform that uses indicators for translating coordinate systems may be more effective than other techniques, such as a force platform that uses force application tools.

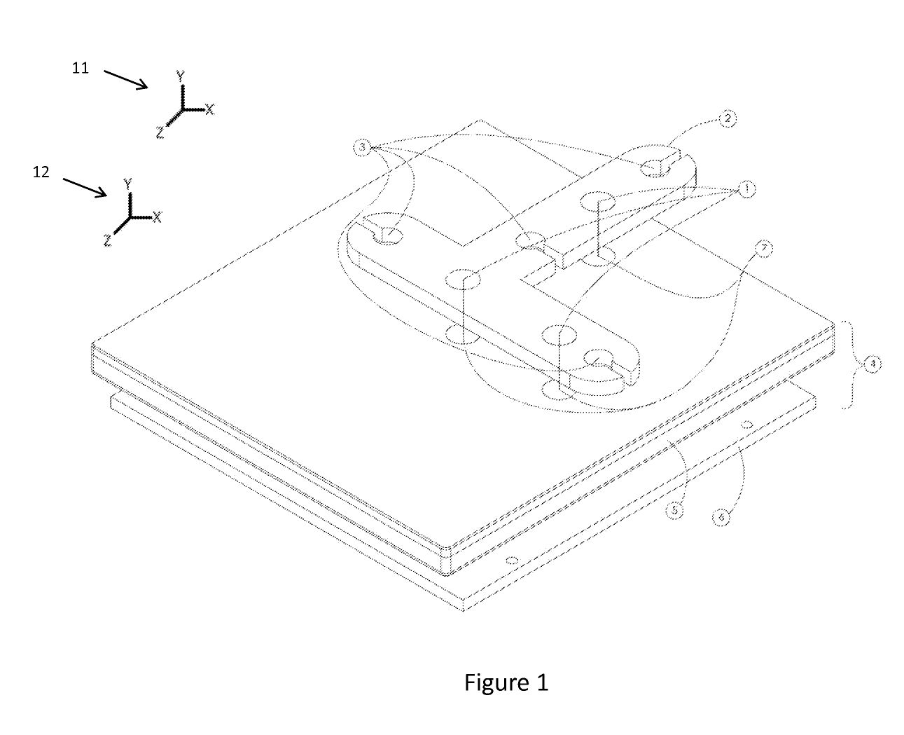

One example of a force platform 4 is illustrated in FIG. 1. Using the techniques described here, a coordinate system 11 of the force platform 4 can be translated to a coordinate system 12 of a spatial measuring system external to the force platform 4 (e.g., a system having a coordinate system external to the force platform).

This force platform 4 includes a top plate 5 and a bottom plate 6 coupled together with force sensing transducers. In this example, the top plate 5 for the force platform has magnets 7 embedded in its surface in a known geometric pattern at a known location. A removable alignment tool 2 is also shown in FIG. 1 that also has magnets 1 embedded in it in a known geometric pattern at a known location.

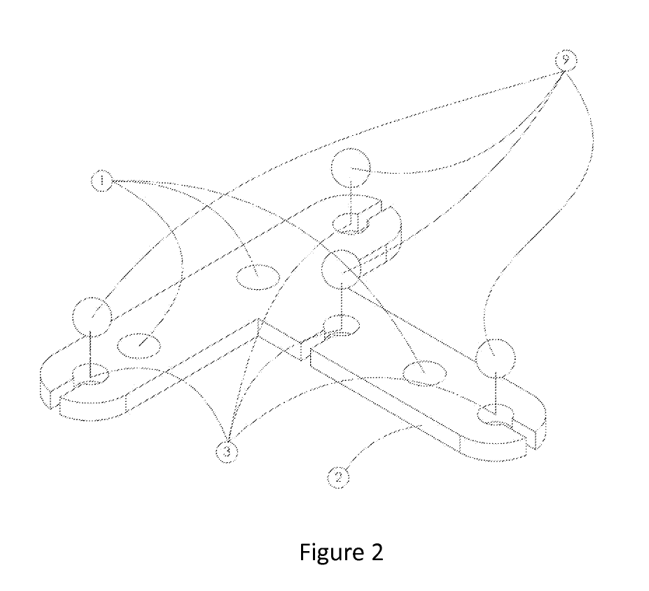

FIG. 2 presents a view of the alignment tool 2. In this example, the alignment tool has multiple optical marker recesses 3 in a known geometric pattern at known locations for locating reflective spheres 9. The markers need not be spherical and could have another kind of shape. The reflective spheres 9 are examples of passive markers (e.g., markers that do not generate their own energy), and any kind of passive marker could be used, such as divots, etched or painted patterns or other indicator that can be resolved by a spatial measuring system.

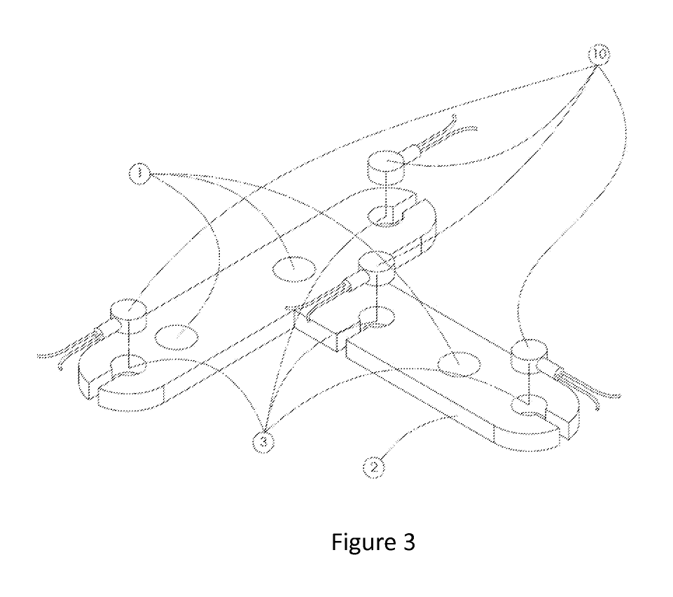

FIG. 3 is another view of the alignment tool 2. In this example the alignment tool has multiple optical marker recesses 3 in a known geometric pattern at known locations for locating light emitting diodes 10. Other kinds of light-emitting markers could be used. The light emitting diodes 10 are examples of active markers (e.g., markers that generate their own energy), and any kind of active marker could be used.

The manner in which the alignment tool is manufactured allows for the easy location of reflective spheres 9 (FIG. 2) or light emitting diodes 10 (FIG. 3) in the optical marker recesses 3 at a known height above the bottom surface of the alignment tool 2. Easily and accurately locating these indicators is enhanced by fabricating the alignment tool 2 from a relatively rigid material that resists bending or other deformation.

Returning to FIG. 1, the geometric pattern of the magnets 7 in the top plate 5 is substantially identical to the geometric pattern of the magnets 1 in the alignment tool 2.

The location of the optical marker recesses 3 with respect to the magnets 1 embedded in the alignment tool 2 is known.

The polarity of the magnets 1 embedded in the alignment tool 2 and the magnets 7 located in the top plate 5 is such that the alignment tool 2 is attracted by magnetic force to the top plate 5. The pattern of the magnets 1 in the alignment tool may assist with the aligning and attracting corresponding magnets 7 located in the top plate 5.

In some examples, only one of either the top plate 5 or alignment tool 2 may include magnets (e.g., the magnets 1 or the magnets 7). For example, the alignment tool 2 may include magnets, and the top plate 5 may include magnetically attracted materials (e.g., magnetically attracted metals such as ferromagnetic metals) arranged in a pattern that corresponds to the pattern of the magnets 1 in the alignment tool 2.

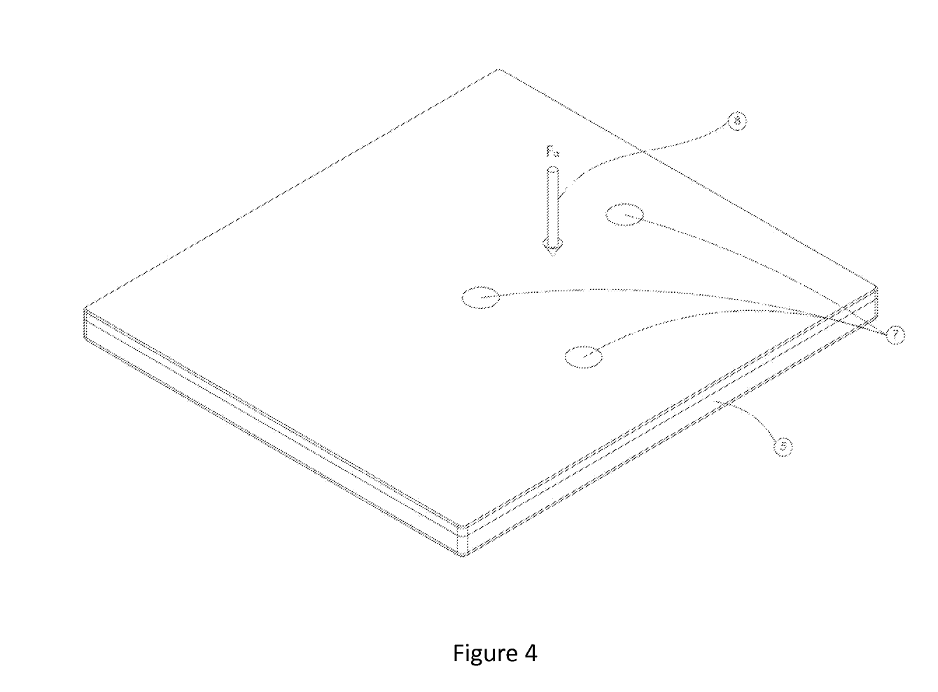

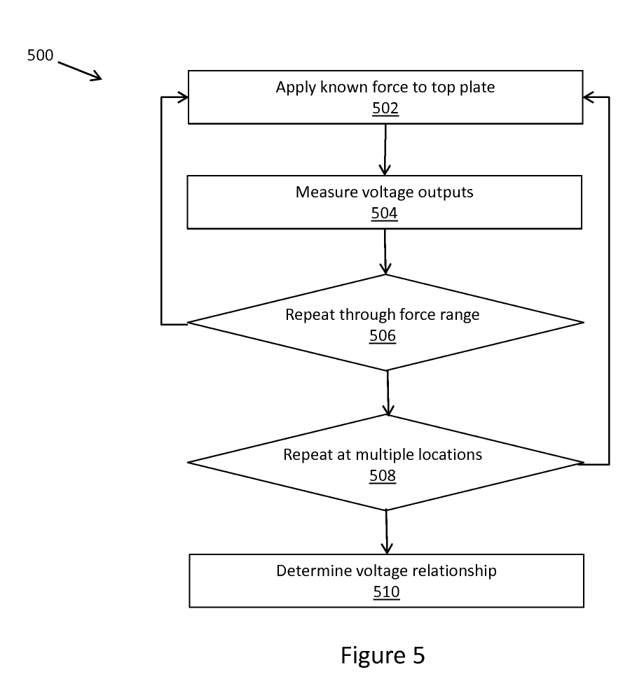

A calibration procedure can be used to develop accuracy when using the alignment tool 2 to determine the unique spatial relationship between an applied force 8 (FIG. 4) and the top plate magnets 7. For example, this relationship can be determined at time of the force platform manufacture at the manufacturer's facility. The use of a coordinate measurement machine or other spatial measurement method is required to establish the relationship of the top plate magnets 7 to the known force. The calibration procedure resolves the magnitude, location and orientation of a wide variety of forces applied to the top plate 5 with respect to the coordinate system 11 of the force platform 4. In some implementations, as shown in FIG. 5, the relationship of the applied force 8 and the top plate magnets 7 is established according to the following calibration procedure 500:

a) Apply 502 a known force to the top plate 5 at a known location with respect to the top plate magnets 7.

b) Measure 504 the voltage outputs of the force transducers that connect the top plate 5 to the bottom plate 6. For example, the voltage outputs could be measured by a digital processing device such as a computer system. The computer system may automatically engage in operations for measuring the voltage outputs.

c) Repeat 506 steps a) and b) above using multiple applied forces throughout a specified force range of the force platform ensuring that the applied forces (typically all the applied forces) are at a known location with respect to the top plate magnets 7.

d) Repeat 508 steps a), b) and c) above at multiple locations across the upper surface and side surfaces of the top plate 5.

e) Determine 510 relationship of voltage from the force transducers to applied forces (e.g., using conventional methods used for force platform calibration).

Once the above procedure 500 has been performed it is possible to determine the location of an arbitrary force vector applied to the force platform 4 with respect to the top plate magnets 7 by subsequent measurement of an arbitrary applied force felt by the transducers.

When a force platform is in use, sometimes users locate the location of the force platform with respect to the location of a spatial motion capture system. This requires translating the coordinate system 11 of the force platform 4 into the coordinate system 12 of the external spatial measuring system.

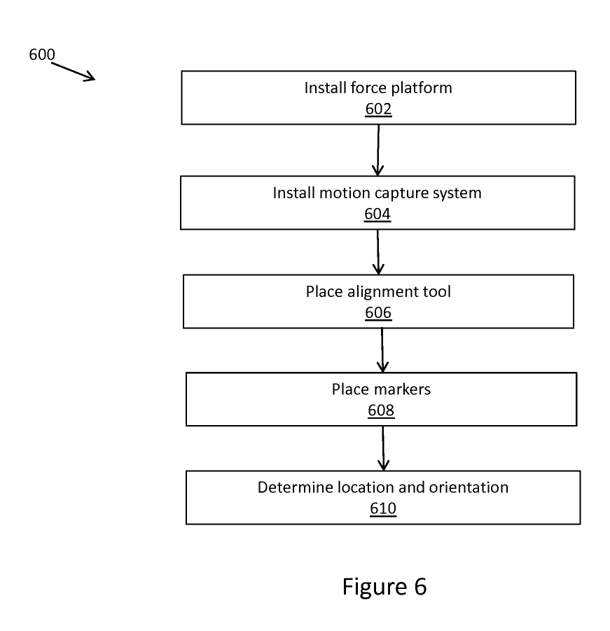

When using the force platform 4, the location and orientation of forces applied to the force platform can be located with respect to the location and orientation of a spatial motion capture system. In some implementations, as shown in FIG. 6, the procedure 600 for establishing this relationship is as follows:

a) Install 602 the pre-calibrated force platform 4 (calibrated according to the procedure described above) in the desired location.

b) Install 604 a spatial motion capture system in the desired location ensuring that the force platform 4 is within range of the spatial motion capture system.

c) Place 606 the alignment tool 2 on top of the top plate 5 of the force platform 4 such that the magnets of the alignment tool 2 is on top of the top plate magnets 7.

d) Place 608 markers, e.g., reflective spheres 9 or light emitting diodes 10, in the optical marker recesses 3 of the alignment tool 2.

e) Using the spatial motion capture system, determine 610 the location and orientation of the alignment tool 2 with respect to the coordinate system 12 of the spatial motion capture system.

The location and orientation of the alignment tool can be used to determine the location and orientation of the force platform 4. Once the location and orientation of the alignment tool 2 with respect to the coordinate 12 of the spatial motion capture system has been determined, the user can from then on translate the voltage output resulting from applying arbitrary forces to the force platform 4 and read in the coordinate system 11 of the force platform 4 into the coordinate system 12 of the external spatial measuring system. The alignment tool 2 can be removed and is no longer need. In some examples, the user of a force platform 4 may cover the upper surface of the top plate 5 with a thin opaque material such a common floor tile. In some instances, the user may wish to repeat the procedure 600 to ensure maximum accuracy if a parameter changes, for example, the relative placement of the motion capture system with respect to the force platform, or a change in resolution resulting from a new camera or other part of the motion capture system.

Several advantages can be realized from one or more aspects of the force platform 4. For example, it enables a researcher to spatially align a force platform with a spatial motion capture system without the need for the researcher to make or use specialized tooling. The force platform can be spatially aligned with a spatial motion capture system with more accuracy, more quickly, and requiring less skill than conventional methods. A controlled and precise calibration of applied forces to the force platform can be obtained in a known coordinate space. The force vectors produced when the force platform is in use can be immediately and directly measured with respect to the coordinate space of a spatial motion capture system. An individual can quickly determine the location and orientation of the force platform with respect to a spatial motion capture system while using less skill than other methods. The accuracy of measuring the location and orientation of the force platform with respect to a spatial motion capture system may be increased compared to other methods. Similarly, the accuracy of measuring ground reaction forces with respect to a spatial motion capture system may be increased. The force platform can be utilized even when covered with a thin opaque material such as a floor tile.

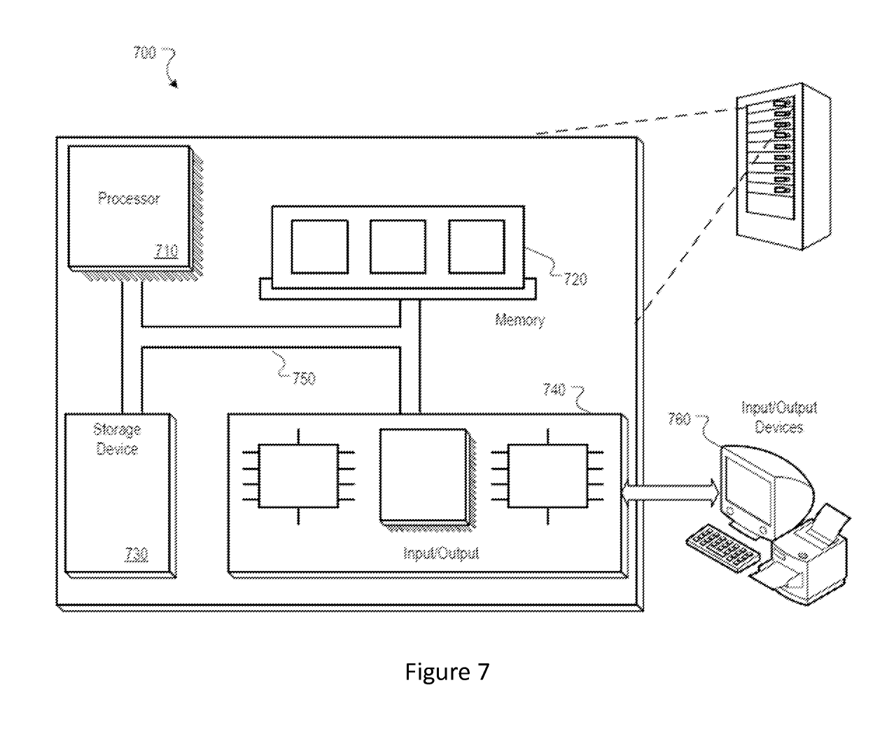

FIG. 7 is block diagram of an example computer system 700. The system 700 could be used, for example, to perform processing steps necessary to translate one coordinate system 11 to another coordinate system 12 (FIG. 1). The system 700 could also be used, for example, to carry out some or all of the steps of the procedures 500, 600 shown in FIGS. 5 and 6. In some examples, the system 700 may be a spatial motion capture system.

The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, or some other large capacity storage device.

The input/output device 740 provides input/output operations for the system 700. In one implementation, the input/output device 740 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 760. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

A number of implementations of the invention have been described. Nevertheless, it will be understood that various modifications may be made without departing from the spirit and scope of the invention. Accordingly, other implementations are within the scope of the following claims.

What is claimed is:

1. A method of manufacturing a force platform, the method comprising:
installing indicators or markers on the force platform such that the spatial coordinates of the indicators or markers are at known locations with respect to applied forces used during the calibration of the force platform.

2. A method comprising:
measuring spatial coordinates of markers or indicators installed on a force platform; and
using the spatial coordinates to transform locations of forces applied to the force platform into a coordinate system external to the force platform.

3. A force platform comprising:
indicators at known locations with respect to applied forces used during the calibration of the force platform,
the indicators being usable by a spatial measurement system to determine the location of the indicators in a coordinate system external to the force platform.

4. The force platform of claim 3, wherein the indicators are magnets.

5. The alignment tool of claim 3, wherein the indicators are reflective spheres.

6. The force platform of claim 3, wherein the indicators are divots.

7. The force platform of claim 3, wherein the indicators are etched patterns.

8. The force platform of claim 3, wherein the indicators are painted patterns.

9. The force platform of claim 3, further comprising pressure transducers that measure the applied forces.

10. An alignment tool comprising:
recesses capable of each receiving an indicator usable by a spatial measurement system to determine the location of the indicators in a coordinate system external to a force platform when the indicators are installed on the force platform; and
magnets arranged in a pattern corresponding to a pattern of magnets in the force platform.

11. The alignment tool of claim 10, wherein the indicators are magnets.

12. The alignment tool of claim 10, wherein the indicators are reflective spheres.

13. The alignment tool of claim 10, wherein the indicators are divots.

14. The alignment tool of claim 10, wherein the indicators are etched patterns.

15. The alignment tool of claim 10, wherein the indicators are painted patterns.

16. The alignment tool of claim 10, wherein the indicators are light emitting diodes.

17. The alignment tool of claim 10, wherein the alignment tool is rigid.
